(19) United States
(12) Patent Application Publication
(10) Pub. No.: US 2002/0071534 A1
(43) Pub. Date: Jun. 13, 2002

(54) Telephone apparatus and calling method in the same

(76) Inventors: Tsutomu Tanaka, Tokyo (JP); Seiji Matsui, Tokyo (JP)

Correspondence Address: Finnegan, Henderson, Farabow, Garrett & Dunner, L.L.P., 1300 I Street, N.W., Washington, DC, 20005-3315, US

(21) Appl. No.: 09/946,683

(22) Filed: Sep. 6, 2001

(30) Foreign Application Priority Data
Dec. 8, 2000 (JP) 2000-373962

(51) Int. Cl. H04M 11/00

(52) U.S. Cl. 379/93.23; 379/90.01; 379/93.17

(57) ABSTRACT

A telephone apparatus displays candidate telephone numbers of a destination person to support a calling operation when the destination person does not answer the call placed to a main telephone number of the same person.

### CROSS-REFERENCE TO RELATED APPLICATIONS

This application is based upon and claims the benefit of priority from the prior Japanese Patent Application No. 2000-373962, filed on Dec. 8, 2000; the entire contents of which are incorporated herein by reference.

### FIELD OF THE INVENTION

The present invention relates to a telephone apparatus, such as a telephone or a cellular phone, having a telephone directory function. The present invention, more particularly, relates to a telephone apparatus equipped with a function that makes it easier for a user to look up a telephone number to call in a telephone directory.

### BACKGROUND

In recent years, there are many users who daily use a plurality of telephone apparatuses, such as a company telephone and a cellular phone as well as a home telephone. Further, with the spread of a cellular phone having a mail function, the number of users each of which has a plurality of mail addresses, such as for home use and private use, has recently increased.

On the other hand, there have been telephones having a telephone directory function capable of registering a plurality of telephone numbers and mail addresses. A user can look up a destination telephone number in a telephone directory using a registration name, such as a full name or a nickname. However, the user can assign only one telephone number or e-mail address to a registration name in the telephone directory. Therefore, it is necessary for the user to provide against cases where an outgoing call can not be received by the destination person. That is, the user has to remember a plurality of registration names assigned to the same person to make a call to another telephone number which appears to be available.

In consideration of the above circumstance, Japanese laid-open patent publication No. 10-164210 (Tokkaihei 10-164210) discloses a technology that makes it easy for a user to look up telephone numbers to call in a telephone directory, by assigning a plurality of telephone numbers to a registration name in the telephone directory. According to the publication, when a user starts a calling operation, telephone numbers corresponding to a registration name are automatically read one after another from the telephone directory. Therefore, even when an outgoing call is not received by a destination person, the user has no need to look up another telephone number using another registration name. The technology can save the user some trouble to look up another registration name assigned to the same destination person by him/herself.

The technology, however, causes the following problems because the user's opportunity of choosing other telephone numbers is restricted and each call is placed spending a predetermined time in a predetermined order, without taking the present time into consideration. When the destination person does not answer a call placed to a first telephone number:

1) even though the user knows another telephone number assigned to the destination person, which appears to be the most available when the call is placed, the user has to wait for a turn to call the telephone number; and

2) a call can be capable of being placed to the destination person's parents' home telephone, for example, even in the middle of the night.

### SUMMARY

In accordance with an embodiment of the present invention, there is provided a telephone apparatus. The apparatus comprises a memory capable of storing a plurality of telephone numbers and a plurality of names each of which corresponds to one or more of the telephone numbers including a first telephone number, means for designating one of the stored names, means for placing a call to the first telephone number of the designated name, and means for displaying the first telephone number of the designated name when the call is placed, and one of the others of the designated name when the call is not received.

Also in accordance with an embodiment of the present invention, there is provided a telephone apparatus. The apparatus comprises a memory capable of storing a plurality of telephone numbers and a plurality of names each of which corresponds to one or more of the telephone numbers including a first telephone number, means for designating one of the stored names, means for placing a call to the first telephone number of the designated name, and means for displaying the stored telephone numbers corresponding to the designated name, with the first telephone number in a state different from the corresponding telephone numbers other than the first telephone number when the call is placed, and with one of the corresponding telephone numbers in a state different from the corresponding telephone numbers other than the one when the call is not received.

Further in accordance with an embodiment of the present invention, there is provided a telephone apparatus. The apparatus comprises a first memory capable of storing a plurality of telephone numbers and a plurality of names each of which corresponds to one or more of the telephone numbers, means for extracting a caller's telephone number from an incoming call, means for searching the first memory for a name corresponding to the extracted caller's telephone number, a second memory capable of storing the extracted caller's telephone number, with the names searched for, means for designating the stored caller's telephone number, means for placing a call to the designated telephone number, and means for displaying the designated telephone number when the call is placed, and one of the other telephone numbers of the caller when the call is not received.

Additionally in accordance with an embodiment of the present invention, there is provided a calling method in a telephone apparatus. The apparatus comprises storing a plurality of telephone numbers and a plurality of names in a memory, the names each of which corresponds to one or more of the telephone numbers, deciding one of the stored telephone numbers of each name as a first telephone number, designating one of the stored names, placing a call to the first telephone number of the designated name, first displaying the first telephone number of the designated name when the call is placed, and second displaying one of the others of the designated name when the call is not received.

Also in accordance with an embodiment of the present invention, there is provided a calling method in a telephone apparatus. The apparatus comprises extracting a caller's telephone number from an incoming call, searching the memory for a name corresponding to the extracted caller's telephone number, storing the extracted caller's telephone number in a second memory, with the names searched for, designating one of the stored caller's telephone number, placing a call to the designated telephone number, displaying the designated telephone number when the call is placed, and displaying one of the other telephone numbers of the caller when the call is not received.

### BRIEF DESCRIPTION OF THE DRAWINGS

The accompanying drawings, which are incorporated in and constitute part of this specification, illustrate various embodiments and/or features of the invention and together with the description, serve to explain the principles of the invention. In the drawings:

FIG. 1 is a block diagram showing a main configuration of a radio telephone apparatus consistent with a first embodiment of the present invention;

FIG. 2 is a functional block diagram showing a configuration of the memory section shown in FIG. 1;

FIG. 3 is a diagram showing the data structure of the telephone directory data storage area shown in FIG. 2;

FIG. 4 is a diagram showing the data structure of the call history data storage area shown in FIG. 2;

FIG. 5 is a flowchart showing the procedure for performing a calling operation by a radio telephone apparatus consistent with the first embodiment;

FIG. 6 is a flowchart showing the procedure for performing a calling operation by a radio telephone apparatus consistent with a second embodiment of the present invention;

FIG. 7 is a diagram showing the data structure of the telephone directory data storage area consistent with a third embodiment of the present invention; and

FIG. 8 is a flowchart showing the procedure for performing a calling operation by a radio telephone apparatus consistent with the third embodiment.

### DETAILED DESCRIPTION

### <First embodiment>

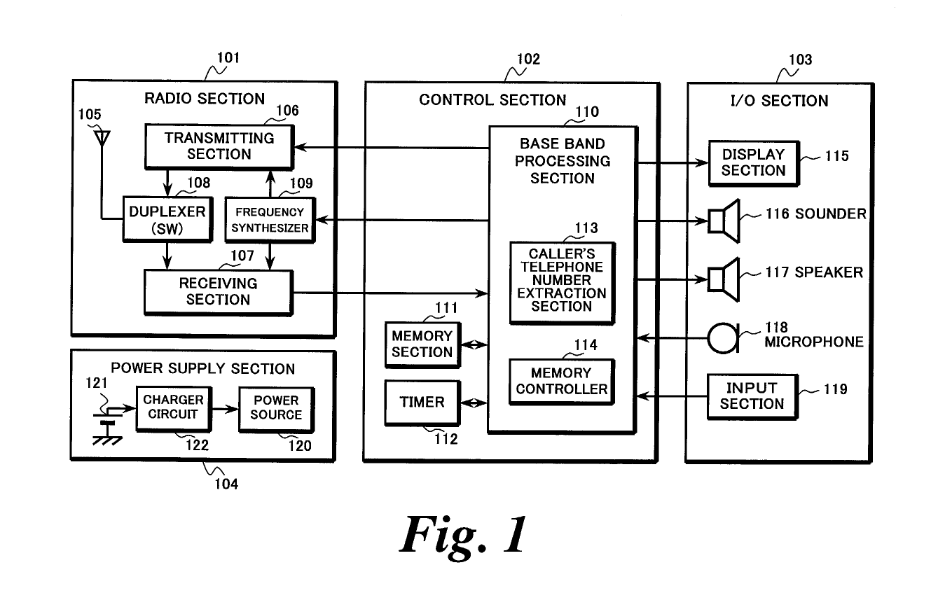

FIG. 1 is a block diagram showing a main configuration of a radio telephone apparatus consistent with a first embodiment of the present invention. In general, a radio telephone apparatus mainly comprises a radio section 101, a control section 102, an input/output (I/O) section 103, and a power supply section 104. The antenna 105 receives a radio signal sent from a base station. The received signal is supplied to the base band processing section 110 via the duplexer 108 and the receiving section 107, and the base band processing section 110 performs signal processing. Conversely, the antenna 105 is supplied with a signal from the base band processing section 110 via the transmitting section 106 and the duplexer 108, and the antenna 105 transmits the signal. The synthesizer 109, being controlled by the base band processing section 110, switches outgoing/incoming channels.

The control section 102 comprises the base band processing section 110, a memory section 111, and a timer 112. The base band processing section 110, having a RAM and a ROM, controls the whole radio telephone apparatus. The memory section 111 stores information on outgoing/incoming call control. The timer 112 measures a lapse of time took for each outgoing/incoming call. The base band processing section 110 has a caller's telephone number extraction section 113 and a memory controller 114. The caller's telephone number extraction section 113 extracts a caller's telephone number from each received data and supplies the extracted telephone number to the memory controller 114. The memory controller 114 manages the information stored in the memory section 111.

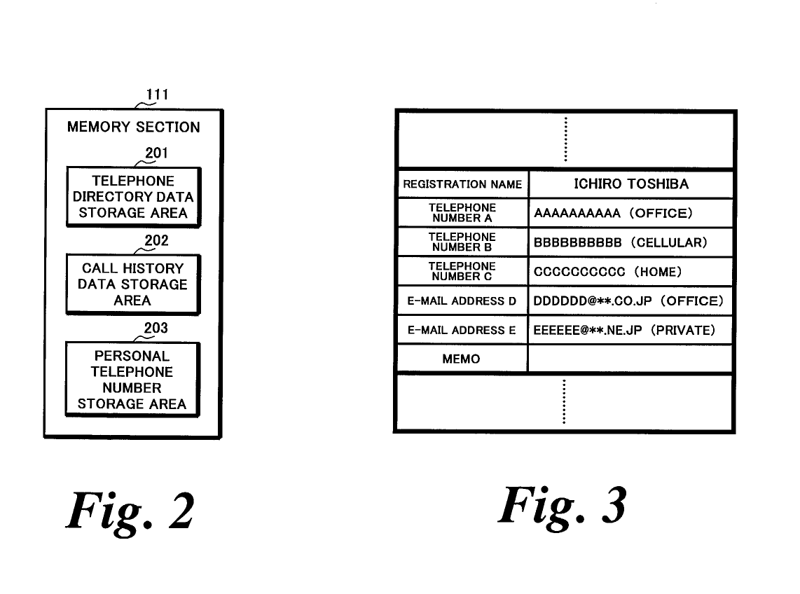

FIG. 2 is a functional block diagram showing a configuration of the memory section shown in FIG. 1 and FIG. 3 is a diagram showing the data structure of the telephone directory data storage area shown in FIG. 2. As shown in FIG. 2, the memory section 111 comprises a telephone directory data storage area 201, a call history data storage area 202, and a personal telephone number storage area 203. As shown in FIG. 3, through an input section 119, a user can register a registration name and store a plurality of telephone numbers, e-mail addresses, and related memorandum, correspondingly to the registration name, in the telephone directory data storage area 201. In FIG. 3, each of character lines “OFFICE”, “HOME”, etc., indicates an attribute of the corresponding telephone number or e-mail address, for users' convenience. These character lines may be stored in a memorandum column.

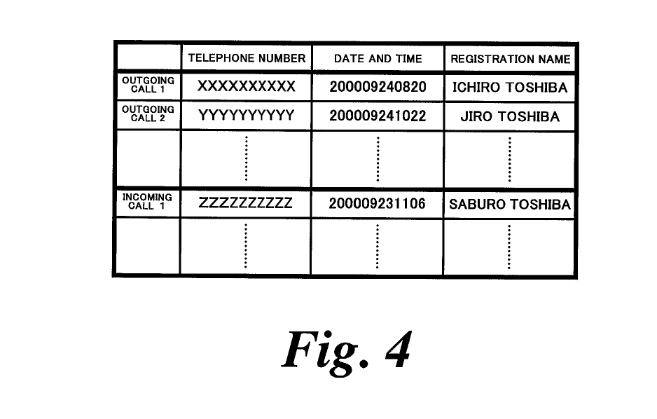

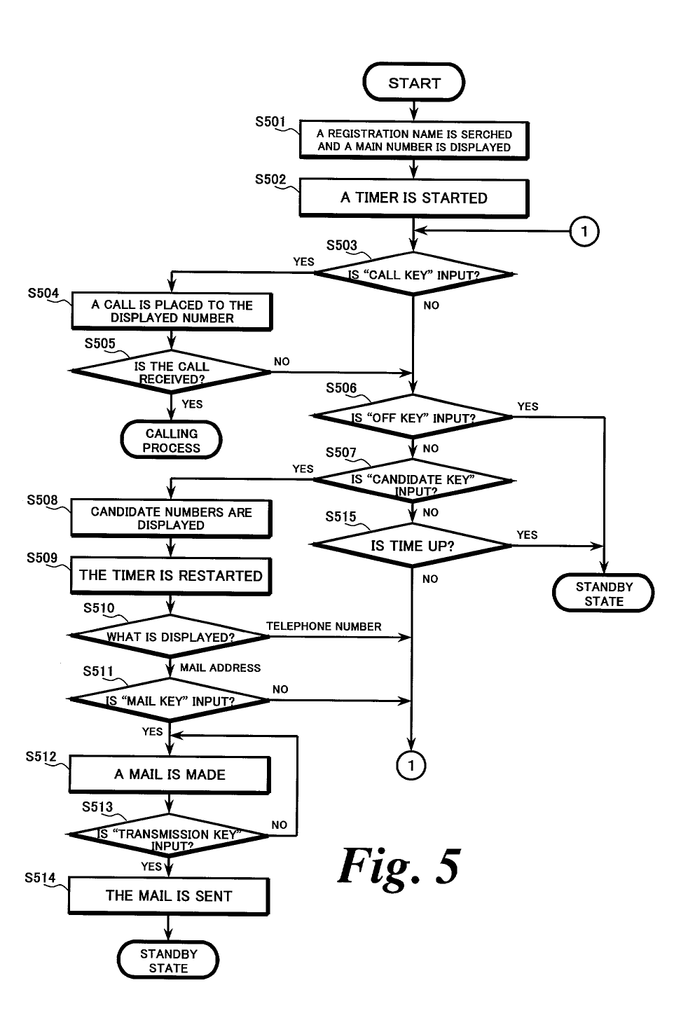

FIG. 4 is a diagram showing the data structure of the call history data storage area. As shown in FIG. 4, the memory controller 114 stores a destination telephone number, date and time of each outgoing/incoming call, and, if needed, a registration name of each destination person or caller, in the call history data storage area 202. When a destination person does not answer a user's call, the memory controller 114 stores the destination telephone number and the date and time in the call history data storage area 202. And the memory controller 114 also stores the registration name in the call history data storage area 202 if a registration name is registered, corresponding to the destination telephone number, with the telephone directory data storage area 201. On the other hand, when the user does not answer a call from a caller for some reasons, the memory controller 114 stores the caller's telephone number and the date and time that the call arrives. And the memory controller 114 also stores the registration name in the call history data storage area 202 If a registration name is registered, corresponding to the caller's telephone number, with the telephone directory data storage area 201. The personal telephone number storage area 203 stores a user's telephone number, which is notified to a destination radio telephone apparatus when the destination person received a call from the user.

The I/O section 103 comprises a display section 115, a sounder 116, a speaker 117, a microphone 118, and the input section 119. The display section 115, consisting of a liquid crystal display (LCD), displays data received by the radio section 101 or data inputted by the user through the input section 119. The sounder 116 notifies the user of an arrival of an incoming call from the caller. The speaker 117 outputs received the caller's voice. The user inputs his/her voice via the microphone 118. The input section 119 may consist of a plurality of keys through which the user inputs various data and instructions.

The power supply section 104 may be a DC/DC converter to supply electric power to each part of the radio telephone apparatus. It comprises a battery 121 such as a lithium battery, a power source 120, which is a circuit for generating a power supply voltage Vcc from the output voltage of the battery, and a charger circuit 122.

FIG. 5 is a flowchart showing the procedure for performing a calling operation by the radio telephone apparatus. When a user inputs, through the input section 119, the whole or part of a registration name and an instruction to search information on the registration name, the base band processing section 110 looks up the information in the telephone directory data storage area 201. One (hereinafter referred to as “main telephone number”) of the telephone numbers corresponding to the registration name stored in the telephone directory data storage area 201 is displayed on the display section 115 with the registration name and its attribute information (Step S501). The main telephone number may be registered with the telephone directory data storage area 201 being attached with the highest priority in advance and updated timely based on operating frequency in use.

The base band processing section 110 starts the timer 112 which measures predetermined time to terminate a calling process if there should be no following input (Step S502). Next, the base band processing section 110 determines whether a key (hereinafter referred to as “outgoing call key”) for making a call is inputted (Step S503). When determining the outgoing call key to be inputted, the base band processing section 110 performs an outgoing call to a destination telephone number which is displayed on the display section 115 at the present time (Step S504). Then the base band processing section 110 detects whether the call is performed call termination response processing by the destination radio telephone apparatus (Step S505). When detecting the call termination response processing, the base band processing section 110 shifts to a usual calling process. Explanation about the calling process is omitted in this embodiment.

On the other hand, when an outgoing call key is not inputted in Step S503 or when the base band processing section 110 does not detect the call termination response processing in Step S505, the base band processing section 110 determines whether a key (hereinafter referred to as “off key”) for ending the outgoing call operation is inputted (Step S506). When the off key is not inputted here, the base band processing section 110 determines whether a key (hereinafter referred to as “candidate key”) for displaying the telephone numbers or e-mail addresses stored in the telephone directory storage area 201 corresponding to the same registration name as candidates (hereinafter referred to as “candidate telephone numbers”) (Step S507). When the candidate key is inputted here, one candidate telephone number and its attribute information are displayed (Step S508), and a timer is restarted (Step S509).

Then, the base band processing section 110 determines whether the candidate number currently displayed is a telephone number or an e-mail address (Step S510). When it is a telephone number, the process restarts from Step S503. On the other hand, when it is an e-mail address, the base band processing section 110 determines whether a key (hereinafter referred to as “mail key”) for sending an e-mail is inputted (Step S511). When the mail key is not inputted, the process restarts from Step S503. When the mail key is inputted, the process shifts to a usual mailing process (Step S512). The explanation about the mailing process is omitted in this embodiment. When a user inputs, after writing an e-mail and checking a destination address, a key (hereinafter referred to as “transmitting key”) for transmitting the e-mail (Step S513), the base band processing section 110 transmits the e-mail (Step S514) and shifts into a standby state.

When the candidate key is not inputted in Step S507, the base band processing section 110 determines whether time is up based on the timer started at Step S502. When time is up, the process shifts into a standby state like the case where the off key is inputted at Step S506. When time is not up, the process restarts from Step S503.

In this embodiment, the radio telephone apparatus displays a main telephone number first, and then displays candidate telephone numbers, responding to a user's instruction. However, all the telephone numbers and e-mail address stored in the telephone directory data storage area 201 may be displayed with one of them blinking as a main telephone number at Step S501. All the candidate telephone numbers stored in the telephone directory data storage area 201 may be displayed with one of them blinking at Step S508.

Moreover, the order of the telephone numbers and e-mail addresses in the telephone directory data storage area 201 may be predetermined by a user or automatically rearranged according to frequency in use. Although every key has a name and a function different from each other, it is not necessary to provide keys for exclusive uses. Namely, each key may be assigned with different functions according to the stage of operation.

As described above, when a destination person does not answer the phone, the telephone apparatus consistent with this embodiment displays, by request, other telephone numbers or e-mail addresses of the same person with their several attribute information. Therefore, the telephone apparatus can support the outgoing call operation, without compelling the user to wait for a turn to call to a desirable telephone number. Moreover, the user can make a call to a candidate telephone number having a possibility that the destination person answers the phone, based on information the user has at the time of outgoing call.

### <Second embodiment>

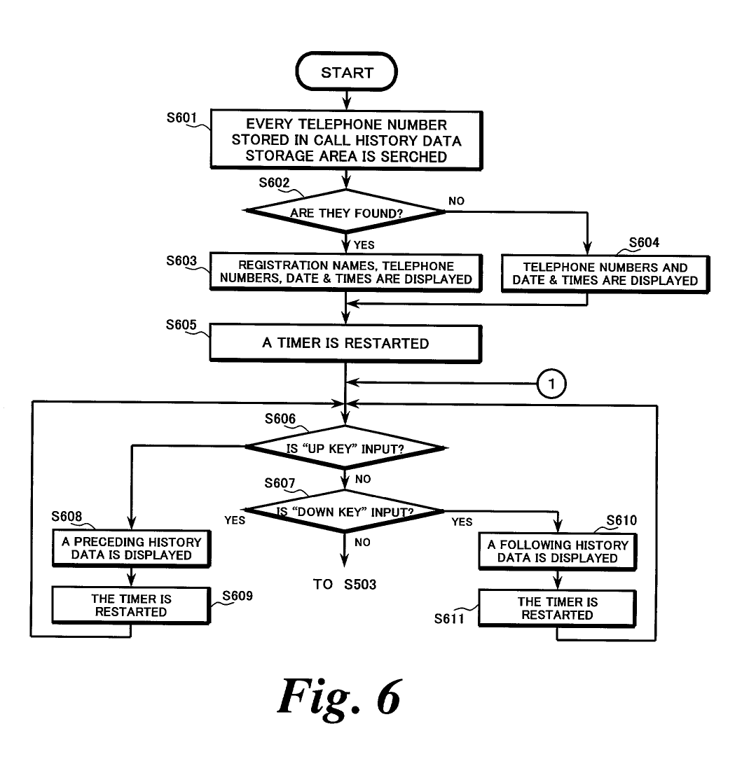

FIG. 6 is a flowchart showing the procedure for performing a calling operation by a radio telephone apparatus consistent with a second embodiment of the present invention. This embodiment realizes, based on an outgoing/incoming call history, calling operation support explained in the first embodiment. In FIG. 6, the calling operation is started when the user performs operation for seeing outgoing/incoming call history. This flow may be placed as the preceding flow of that shown in FIG. 5.

When detecting an input of a key (hereinafter referred to as “redial key”) for performing an outgoing call based on an outgoing/incoming history stored in the call history data storage area 202, the base band processing section 110 determines whether each data stored in the call history data storage area 202 is registered with the telephone directory data memory section 201 (Step S601). When they are registered (Step S602), the base band processing section 110 displays a telephone number and outgoing/incoming date and time with a corresponding registration name on the display section 115 (Step S603). When they are not registered (Step S602), the base band processing section 110 displays only the telephone number and outgoing/incoming date and time (Step S604). All the histories may be displayed with one of them blinking.

The base band processing section 110 starts the timer 112 to terminate the calling operation when there should be no following operation (Step S605). Next, the base band processing section 110 determines whether a key (hereinafter referred to as “up key”) for moving up a cursor or a key (hereinafter referred to as “down key”) for moving down the cursor is inputted (Steps S606 and S607). When no key is inputted at Steps S606 or S607, namely, when the user wants to make a call to a telephone number currently displayed, the process shifts at Step S503 of FIG. 5 to perform the calling process to the telephone number. When time is not up at Step S515 of FIG. 5, for example, the process restarts from Step 606 of FIG. 6.

When the up key is inputted at Step S606, the base band processing section 110 one of the displays history data preceding the history data currently displayed or blinking (Step S608). The timer 112 is restarted (Step S609) and the process restarts from Step S606. On the other hand, when the down is inputted at Step S607, the base band processing section 110 displays one of the history data following the history data currently displayed or blinking (Step S610). The timer 112 is restarted (Step S611) and the process restarts from Step S606. History data may be arranged in order of the time or the registration name.

As described above, because the calling operation support explained in the first embodiment can be realized based on an outgoing/incoming call history, the radio telephone apparatus consistent with this embodiment makes it easier for a user to perform a calling operation.

### <Third embodiment>

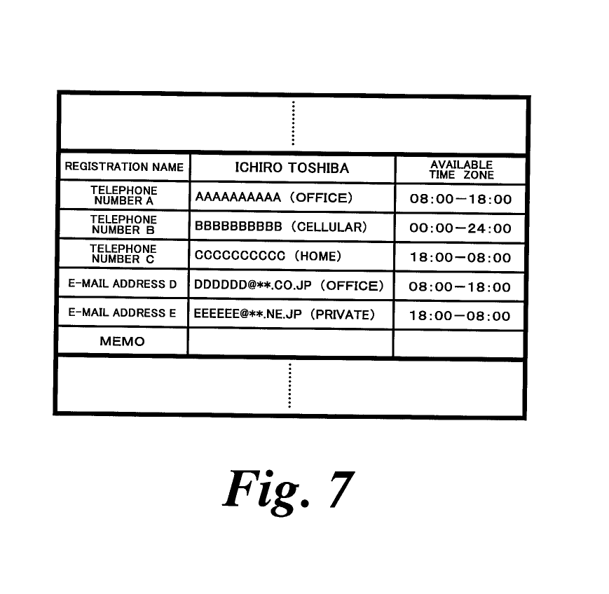

FIG. 7 is a diagram showing the data structure of the telephone directory data storage area 201 consistent with a third embodiment of the present invention. This embodiment realizes the calling operation supports explained in the first and second embodiments, taking the time of calling into consideration. As shown in FIG. 7, the telephone directory data storage area 201 in this embodiment stores available time zones of each telephone number or mail address for each registration name as well as a plurality of telephone numbers, mail addresses, and related memorandum, etc. The available time zones may be inputted like the telephone numbers and displayed with the telephone numbers to support the user's calling to a telephone number appropriate at the time of calling.

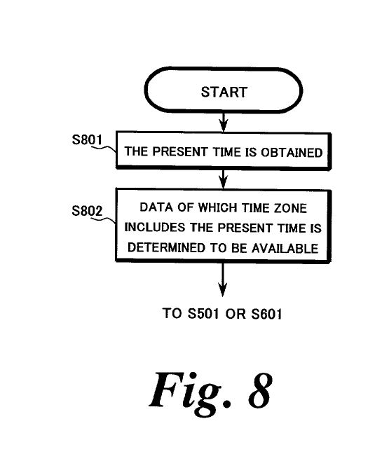

FIG. 8 is a flowchart showing the procedure for performing a calling operation by a radio telephone apparatus consistent with the third embodiment. This flow may be placed as the preceding flow of that shown in FIG. 5 or 6. As shown in FIG. 8, the base band processing section 110 determines whether the time of calling to a telephone number is during the available time zone of the telephone number. This function, which narrows down the candidate telephone numbers according to the time of calling, may be preset in the radio telephone apparatus or started when the user selects the mode of this function.

When starting the flow of FIG. 5 or 6, the base band processing section 110 obtains the present time from the timer 112 (Step S801) and instructs the memory control section 114 to make only the telephone numbers or e-mail addresses of which available time zones include the present time available to call (Step S802). With regards to the calling based on an incoming history, the base band processing section 110 may narrow down the telephone numbers to call according to each available time zone, after a predetermined time of incoming call.

According to the third embodiment, it is possible to display only available ones at the time of calling among the telephone numbers and e-mail addresses corresponding to each registration name. As a result, it is possible to provide a calling operation support further convenient for a user.

Although the above embodiments are explained referring to a radio telephone apparatus as an example, they can be applied not only to radio telephone apparatuses but also wire communication apparatuses, for example.

What is claimed is:

1. A telephone apparatus, comprising:
a memory capable of storing a plurality of telephone numbers and a plurality of names each of which corresponds to one or more of the telephone numbers including a first telephone number;
means for designating one of the stored names;
means for placing a call to the first telephone number of the designated name; and
means for displaying the first telephone number of the designated name when the call is placed, and one of the others of the designated name when the call is not received.

2. The apparatus of claim 1, wherein:
the call placing means places another call to one of the other telephone numbers when it is designated though the designating means.

3. The apparatus of claim 1, wherein:
the memory is capable of storing a plurality of e-mail addresses, each of the stored names corresponds to one or more of the e-mail addresses;
the displaying means displays the e-mail addresses of the designated name when the call is not received; and
the call placing means sends an e-mail to one of the e-mail addresses when it is designated though the designating means.

4. The apparatus of claim 1, wherein:
the memory is capable of storing available time zones for each telephone number; and
the displaying means displays the available time zones when the other telephone numbers of the designated name are displayed.

5. The apparatus of claim 1, wherein:
the memory is capable of storing available time zones for each telephone number; and
the displaying means displays the other telephone numbers each of which available time zone includes the present time.

6. The apparatus of claim 1, wherein:
the telephone numbers stored in the memory are placed in order of frequency in use; and
the first telephone number is updated based on the order.

7. A telephone apparatus, comprising:
a memory capable of storing a plurality of telephone numbers and a plurality of names each of which corresponds to one or more of the telephone numbers including a first telephone number;
means for designating one of the stored names;
means for placing a call to the first telephone number of the designated name; and
means for displaying the stored telephone numbers corresponding to the designated name, with the first telephone number in a state different from the corresponding telephone numbers other than the first telephone number when the call is placed, and with one of the corresponding telephone numbers in a state different from the corresponding telephone numbers other than the one when the call is not received.

8. The apparatus of claim 1, wherein:
the displaying means displays the first telephone number blinking.

9. A telephone apparatus, comprising:
a first memory capable of storing a plurality of telephone numbers and a plurality of names each of which corresponds to one or more of the telephone numbers;
means for extracting a caller's telephone number from an incoming call;
means for searching the first memory for a name corresponding to the extracted caller's telephone number;
a second memory capable of storing the extracted caller's telephone number, with the names searched for;
means for designating the stored caller's telephone number;
means for placing a call to the designated telephone number; and
means for displaying the designated telephone number when the call is placed, and one of the other telephone numbers of the caller when the call is not received.

10. The apparatus of claim 9, wherein:
the call placing means places another call to one of the other telephone numbers of the caller when it is designated though the designating means.

11. The apparatus of claim 9, wherein:
the first memory is capable of storing a plurality of e-mail addresses, each of the stored names corresponds to one or more of the e-mail addresses;
the displaying means displays the e-mail addresses of the caller when the call is not received; and
the call placing means sends an e-mail to one of the e-mail addresses when it is designated though the designating means.

12. The apparatus of claim 9, wherein:
the first memory is capable of storing available time zones for each telephone number; and
the displaying means displays the available time zones when the other telephone numbers of the caller are displayed.

13. The apparatus of claim 9, wherein:
the first memory is capable of storing available time zones for each telephone number; and
the displaying means displays the other telephone numbers of the caller, each of which available time zone includes the present time.

14. The apparatus of claim 9, wherein:
the telephone numbers stored in the first memory are placed in order of frequency in use; and
the first telephone number is updated based on the order.

15. A calling method in a telephone apparatus, comprising:
storing a plurality of telephone numbers and a plurality of names in a memory, the names each of which corresponds to one or more of the telephone numbers;
deciding one of the stored telephone numbers of each name as a first telephone number;
designating one of the stored names;
placing a call to the first telephone number of the designated name;
first displaying the first telephone number of the designated name when the call is placed; and
second displaying one of the others of the designated name when the call is not received.

16. The method of claim 15, further comprising:
designating one of the other telephone numbers; and
placing another call to the designated telephone number.

17. The method of claim 15, further comprising:
storing available time zones for each telephone number in the memory; and
the method wherein:
the second displaying includes displaying the available time zones with the other telephone numbers.

18. The method of claim 15, further comprising:
storing available time zones for each telephone number in the memory; and
the method wherein:
the second displaying includes displaying the other telephone numbers each of which available time zone includes the present time.

19. The method of claim 15, further comprising:
placing the telephone numbers stored in the memory in order of frequency in use; and
updating the first telephone number based on the order.

20. A calling method in a telephone apparatus, comprising:
extracting a caller's telephone number from an incoming call;
searching the memory for a name corresponding to the extracted caller's telephone number;
storing the extracted caller's telephone number in a second memory, with the names searched for;
designating one of the stored caller's telephone number;
placing a call to the designated telephone number;
displaying the designated telephone number when the call is placed; and
displaying one of the other telephone numbers of the caller when the call is not received.

21. The method of claim 20, wherein: designating one of the other telephone numbers of the caller; and
placing another call to the telephone number.
